(19) United States
(12) Patent Application Publication
(10) Pub. No.: US 2024/0217017 A1
(43) Pub. Date: Jul. 4, 2024

(54) WELDING APPARATUS AND TEMPERATURE MEASURING APPARATUS

(71) Applicant: Kabushiki Kaisha Kobe Seiko Sho (Kobe Steel, Ltd.), Kobe-shi (JP)

(72) Inventors: Yasuharu SAKURAI, Fujisawa-shi (JP); Yoshiya TAKEMURA, Fujisawa-shi (JP); Shigeto TAKADA, Fujisawa-shi (JP); Atsushi FUKUNAGA, Fujisawa-shi (JP); Taisei FUJIMOTO, Fujisawa-shi (JP)

(73) Assignee: Kabushiki Kaisha Kobe Seiko Sho (Kobe Steel, Ltd.), Kobe-shi (JP)

(21) Appl. No.: 18/556,285

(22) PCT Filed: Mar. 25, 2022
(86) PCT No.: PCT/JP2022/014702

§ 371 Date: Oct. 19, 2023

(30) Foreign Application Priority Data
Apr. 20, 2021 (JP) 2021-071102

(51) Int. Cl. B23K 9/095; B23K 9/12

(52) U.S. Cl. CPC B23K 9/0956; B23K 9/12

(57) ABSTRACT

A welding device including a welding torch; a movable portion; a measurement unit that is provided in the movable portion and is capable of measuring a temperature of the one weld bead and/or the object to be welded in the vicinity of the one weld bead at a predetermined period; a cover portion capable of covering the measurement unit at least; and a driving unit configured to drive a support member supporting the cover portion to move the support member in a predetermined direction to bring the cover portion into a state of covering the measurement unit when the weld bead is formed, and drive the support member to move the support member in a direction opposite to the predetermined direction to bring the cover portion into a state of exposing the measurement unit in the predetermined period.

### TECHNICAL FIELD

The present invention relates to a welding device and a temperature measuring device.

### BACKGROUND ART

When multilayer welding is performed on an object to be welded, after one weld bead is formed and before a next welding pass is welded, a temperature of the one weld bead or a temperature of the object to be welded in the vicinity of the one weld bead may be measured (for example, see Patent Literature 1).

### CITATION LIST

### Patent Literature

Patent Literature 1: JP2008-275482A

### SUMMARY OF INVENTION

### Technical Problem

Here, when welding is performed on an object to be welded, spatter, fume, and radiant heat are generated with formation of a weld bead. When an influence of the spatter, the fume, and the radiant heat affects a measurement unit that measures a temperature, there is a possibility that a problem may occur in the measurement unit. Therefore, it is necessary to protect the measurement unit from the spatter, the fume, and the radiant heat generated with the formation of the weld bead. In this case, for example, in order to reduce a possibility of malfunction, failure, or the like of a device and interference during operation, it is preferable that a configuration for protecting the measurement unit is not complicated but simple and compact.

An object of the present invention is to protect a measurement unit that measures a temperature with a simple and compact configuration.

### Solution to Problem

With this object in view, the present invention is a welding device capable of performing multilayer welding on an object to be welded, including: a welding torch; a movable portion that moves the welding torch; a measurement unit that is provided in the movable portion and is capable of measuring, in a predetermined period after one weld bead is formed and before a next welding pass is welded, at least one of a temperature of the one weld bead or a temperature of the object to be welded in the vicinity of the one weld bead; a cover portion capable of covering the measurement unit at least; and a driving unit that drives a support member supporting the cover portion to move the support member in a predetermined direction to bring the cover portion into a state of covering the measurement unit when the weld bead is formed, and drives the support member to move the support member in a direction opposite to the predetermined direction to bring the cover portion into a state of exposing the measurement unit in the predetermined period.

Here, the driving unit may drive the support member using compressed air.

There may be provided a supply unit that supplies compressed air used when another tool is used instead of the welding torch, and the driving unit may drive the support member using the compressed air supplied by the supply unit.

There may be provided a guide portion that guides movement of the cover portion separately from the driving unit when the cover portion moves.

The guide portion may cover a periphery of the measurement unit such that temperature measurement by the measurement unit is possible in a state in which the cover portion exposes the measurement unit.

There may be provided a display unit that indicates a position of the temperature measurement by the measurement unit on the object to be welded.

The display unit may be covered together with the measurement unit by the cover portion when the cover portion covers the measurement unit, and may be exposed together with the measurement unit when the cover portion exposes the measurement unit.

The movable portion may include a plurality of link portions configured to be movable via a drive shaft, and the measurement unit may be held by the link portion to which the welding torch is attached.

The measurement unit may be disposed on at least one side in a left-right direction of the movable portion in a reference posture.

With this object in view, the present invention is a temperature measuring device used in a welding device capable of performing multilayer welding on an object to be welded by moving a welding torch by a movable portion, the temperature measuring device including: a measurement unit that is provided in the movable portion and is capable of measuring, in a predetermined period after one weld bead is formed and before a next welding pass is welded, at least one of a temperature of the one weld bead or a temperature of the object to be welded in the vicinity of the one weld bead; a cover portion capable of covering the measurement unit at least; and a driving unit that drives a support member supporting the cover portion to move the support member in a predetermined direction to bring the cover portion into a state of covering the measurement unit when the weld bead is formed, and drive the support member to move the support member in a direction opposite to the predetermined direction to bring the cover portion into a state of exposing the measurement unit in the predetermined period.

### Advantageous Effects of Invention

According to the present invention, it is possible to protect the measurement unit that measures a temperature with a simple and compact configuration.

### BRIEF DESCRIPTION OF DRAWINGS

FIG. 1 is an overall view of a welding device of the present embodiment.

FIG. 2 is an enlarged side view of a tool portion of a welding robot in a reference posture as viewed from a Y-axis direction.

FIG. 3 is an enlarged plan view of the tool portion of the welding robot in the reference posture as viewed from a Z-axis direction.

FIG. 4 is an exploded perspective view of a temperature measuring device of the present embodiment.

FIG. 5 is an overall view of a sensor unit of the present embodiment.

FIG. 6 is a cross-sectional view of the temperature measuring device of the present embodiment.

FIG. 7A is an explanatory view of an operation of the temperature measuring device of the present embodiment, and is a view of the temperature measuring device as viewed from an object side in an A direction.

FIG. 7B is an explanatory view of an operation of the temperature measuring device of the present embodiment, and is a view of the temperature measuring device as viewed from the object side in the A direction.

FIG. 8 is a flowchart illustrating an example of an operation flow of the welding device of the present embodiment.

### DESCRIPTION OF EMBODIMENTS

Hereinafter, embodiments of the present invention will be described with reference to the accompanying drawings.

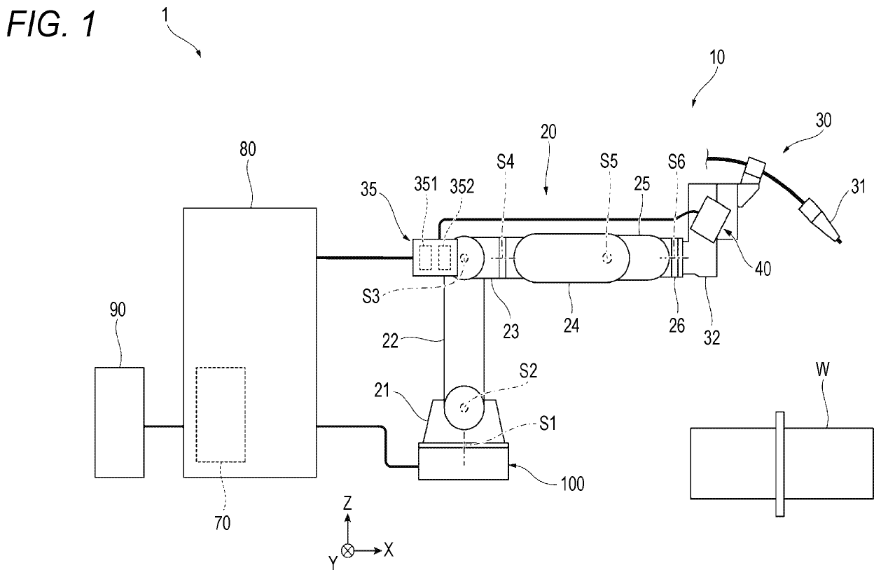

FIG. 1 is an overall view of a welding device 1 of the present embodiment.

As illustrated in FIG. 1, in the description of the present embodiment, a horizontal direction refers to an X axis and a Y axis. The X axis and the Y axis are orthogonal to each other. In addition, a vertical direction refers to a Z axis. The Z axis is orthogonal to the X axis and the Y axis, respectively.

As illustrated in FIG. 1, the welding device 1 includes a welding robot 10 that welds workpieces W as an example of an object to be welded which is a welding target, an air compressor 70 as an example of a supply unit that supplies compressed air, a control device 80 that controls an operation of the welding robot 10, and a power supply 90 for supplying a welding current.

### [Welding Robot 10]

There are various types of welding robots 10 according to applications. In the description of the present embodiment, an example of the welding robot 10 used for welding a steel frame is used. In addition, the welding robot 10 of the present embodiment is an articulated robot. Further, the welding robot 10 of the present embodiment is a robot that performs arc welding on the workpiece W.

As illustrated in FIG. 1, the welding robot 10 includes a base portion 100, a movable manipulator portion 20, and a tool portion 30 mounted on the manipulator portion 20. Further, the welding robot 10 further includes a relay box 35 that relays an electrical signal or the like to the control device 80 and relays compressed air from the air compressor 70, and a temperature measuring device 40 that measures a temperature.

### (Base Portion 100)

The base portion 100 is fixed to an installation target such as a floor. Further, the base portion 100 supports respective components of the welding robot 10 including the manipulator portion 20.

### (Manipulator Portion 20)

The manipulator portion 20 includes a turning portion 21, a lower arm portion 22, an upper arm portion 23, a wrist turning portion 24, a wrist bending portion 25, and a wrist rotating portion 26. In the following description, in a case where the turning portion 21, the lower arm portion 22, the upper arm portion 23, the wrist turning portion 24, the wrist bending portion 25, and the wrist rotating portion 26 are not distinguished, each of those is referred to as a “link portion”.

The turning portion 21 is connected to the base portion 100 via a first drive shaft S1 along the vertical direction. The turning portion 21 is turnable about the first drive shaft S1 with respect to the base portion 100.

The lower arm portion 22 is connected to the turning portion 21 via a second drive shaft S2 along the horizontal direction. The lower arm portion 22 is rotatable about the second drive shaft S2 with respect to the turning portion 21.

The upper arm portion 23 is connected to the lower arm portion 22 via a third drive shaft S3 along the horizontal direction. The upper arm portion 23 is rotatable about the third drive shaft S3 with respect to the lower arm portion 22.

The wrist turning portion 24 is connected to the upper arm portion 23 via a fourth drive shaft S4. The wrist turning portion 24 is rotatable about the fourth drive shaft S4 with respect to the upper arm portion 23.

The wrist bending portion 25 is connected to the wrist turning portion 24 via a fifth drive shaft S5 along the horizontal direction. The wrist bending portion 25 is rotatable about the fifth drive shaft S5 with respect to the wrist turning portion 24.

The wrist rotating portion 26 is connected to the wrist bending portion 25 via a sixth drive shaft S6. The wrist rotating portion 26 is rotatable about the sixth drive shaft S6 with respect to the wrist bending portion 25. The tool portion 30 is mounted on the wrist rotating portion 26 of the present embodiment.

The manipulator portion 20 moves each link portion using the first drive shaft S1 to the sixth drive shaft S6 as rotation centers, thereby moving a welding torch 31 to be described later of the tool portion 30 to any position with respect to the workpiece W.

Next, a reference posture of the welding robot 10 will be described.

The reference posture in the present embodiment is a state in which rotation angles of the first drive shaft S1 to the sixth drive shaft S6 in the welding robot 10 are set to origin angles at which an angle formed with respect to a predetermined reference is 0 degrees.

In the present embodiment, the origin angles can be exemplified as angles at which the welding robot 10 is in the following states. For example, as illustrated in FIG. 1, the origin angle is an angle of the second drive shaft S2 at which the lower arm portion 22 is brought into a state of being along the vertical direction. Further, the origin angle is angles of the third drive shaft S3 and the fifth drive shaft S5 at which each of the upper arm portion 23 and the wrist bending portion 25 is brought into a state of being along the horizontal direction. Further, the origin angle is angles of the first drive shaft S1, the fourth drive shaft S4, and the sixth drive shaft S6 at which the second drive shaft S2, the third drive shaft S3, and the fifth drive shaft S5 are brought into a state of being parallel to each other.

### (Tool Portion 30)

The tool portion 30 includes the welding torch 31 that performs welding and a torch supporting portion 32 that supports the welding torch 31.

While feeding a welding wire, the welding torch 31 causes a current supplied from the power supply 90 to flow through the welding wire to form a weld bead on the workpiece W.

The torch supporting portion 32 holds the welding torch 31 at one end portion. In addition, the torch supporting portion 32 is connected to the wrist rotating portion 26 at the other end portion. The torch supporting portion 32 moves integrally with the wrist rotating portion 26. Further, the torch supporting portion 32 causes the welding torch 31 supported by the torch supporting portion 32 to be moved integrally with the wrist rotating portion 26.

In the welding robot 10 of the present embodiment, replacement is possible with a tool different from the above-described welding torch 31 in the tool portion 30. In the welding robot 10 of the present embodiment, instead of the welding torch 31 and the torch supporting portion 32, a slag chipper (not illustrated) can be mounted on the wrist rotating portion 26 as the tool portion 30. The slag chipper is a tool for removing slag generated in the weld bead formed on the workpiece W. The slag chipper removes the slag generated in the weld bead by, for example, bringing a vibrating needle into contact with the weld bead.

### (Relay Box 35)

The relay box 35 includes an air control unit 351 and a temperature sensor amplifier 352.

In the present embodiment, compressed air is supplied from the air compressor 70 to a tool such as the slag chipper by a flow path of air (hereinafter, referred to as “air path”). In addition, the compressed air is supplied from the air compressor 70 to an air cylinder portion 60 to be described later through the air path.

The air control unit 351 controls a flow of the compressed air in the air path. The air control unit 351 controls a flow velocity of the compressed air flowing through the air path using an air flow velocity control valve. In addition, the air control unit 351 opens and closes a flow path of the compressed air in the air path by using an air opening/closing control valve. In this way, the air control unit 351 controls the flow velocity and a flow rate of the compressed air flowing through the air path, and drives, for example, a blade of the slag chipper or the air cylinder portion 60 to be described later.

The air control unit 351 operates based on a control command from the control device 80.

The temperature sensor amplifier 352 is electrically connected to a sensor cable 55 to be described later of the temperature measuring device 40. The temperature sensor amplifier 352 amplifies a voltage output from a temperature sensor 52 to be described later via the sensor cable 55. Further, the temperature sensor amplifier 352 sends the amplified voltage to the control device 80. In the present embodiment, the control device 80 converts an input voltage value into a measurement temperature. However, the temperature sensor amplifier 352 may convert a voltage value acquired from the temperature measuring device 40 into a measurement temperature and send the measurement temperature to the control device 80.

### (Temperature Measuring Device 40)

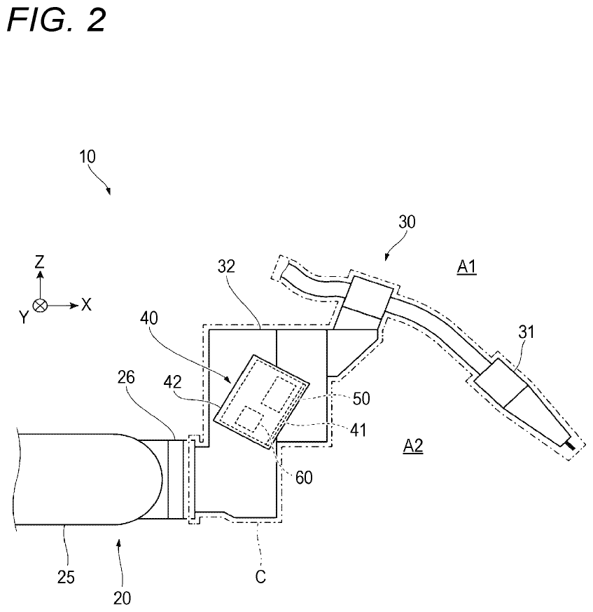

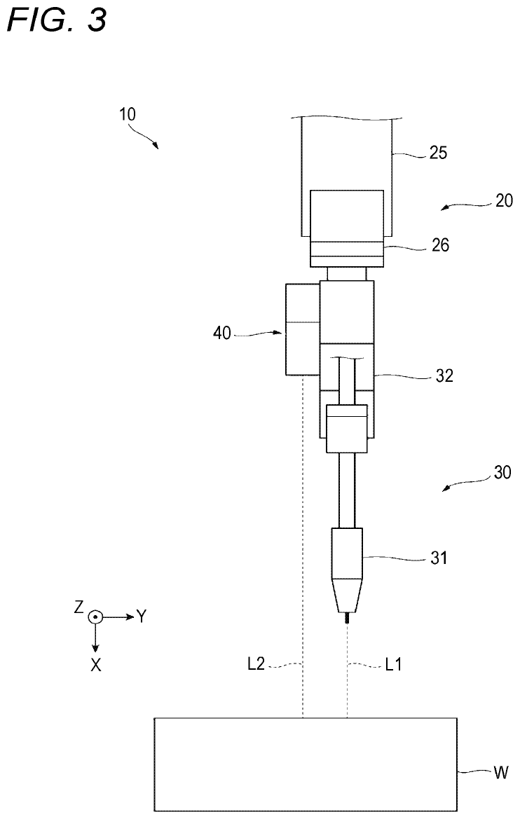

FIG. 2 is an enlarged side view of the tool portion 30 of the welding robot 10 in the reference posture as viewed from a Y-axis direction. FIG. 3 is an enlarged plan view of the tool portion 30 of the welding robot 10 in the reference posture as viewed from a Z-axis direction.

As illustrated in FIG. 2, the temperature measuring device 40 is provided in a movable portion that moves the welding torch 31 in the welding robot 10, such as the manipulator portion 20 and the torch supporting portion 32 connected to the manipulator portion 20. Further, the temperature measuring device 40 of the present embodiment measures, in a predetermined period after one weld bead for a workpiece W is formed and before a next welding pass is welded to the workpiece W, a temperature of the one weld bead or a temperature of the workpiece W in the vicinity of the one weld bead. The temperature measuring device 40 of the present embodiment may measure both the temperature of the one weld bead and the temperature of the workpiece W in the vicinity of the one weld bead in the above-mentioned predetermined period.

Here, the above-described vicinity of the weld bead can be exemplified by, for example, a position within the workpiece W about 10 mm away from the weld bead formed on the workpiece W. Further, a position of the temperature measurement in the one weld bead can be exemplified by, for example, one position of a central portion in a longitudinal direction of the formed weld bead. The temperature measuring device 40 may measure temperatures of a plurality of different positions in the longitudinal direction of the weld bead of one welding pass. The same applies to a case where the temperature of the workpiece W in the vicinity of the weld bead is measured.

As illustrated in FIG. 2, the temperature measuring device 40 of the present embodiment is provided in the torch supporting portion 32 of the tool portion 30. As described above, the torch supporting portion 32 is connected to the wrist rotating portion 26 of the manipulator portion 20. Therefore, the temperature measuring device 40 is held by the wrist rotating portion 26 via the torch supporting portion 32. In this way, the temperature measuring device 40 is moved integrally with the welding torch 31 by the wrist rotating portion 26 which is an end of the manipulator portion 20.

In addition, in the welding robot 10 of the present embodiment, by providing the temperature measuring device 40 in the torch supporting portion 32 that supports the welding torch 31, a relative positional relation between the temperature measuring device 40 and the welding torch 31 is fixed.

Here, the welding robot 10 moves the welding torch 31 to a predetermined position with respect to the workpiece W to perform welding. In this case, it is necessary for the welding robot 10 to move the welding torch 31 such that a movable portion such as the torch supporting portion 32 that moves the welding torch 31 with respect to the workpiece W does not interfere with the workpiece W. That is, in the welding robot 10, movement of the welding torch 31 is restricted by an outer shape of the movable portion such as the torch supporting portion 32. For example, in order not to obstruct the movement of the welding torch 31 with respect to the workpiece W, it is preferable that structural portions other than the welding torch 31 and the torch supporting portion 32 are not provided in an upper region A1 and a lower region A2 in the vertical direction of the tool portion 30 as illustrated in FIG. 2.

Here, as illustrated in FIG. 3, in the welding robot 10 of the present embodiment, when the welding robot 10 in the reference posture is viewed on an upper side in the Z-axis direction which is the vertical direction and from a direction which the manipulator portion 20 is along in the X-axis direction, the temperature measuring device 40 is disposed on one side in the left-right direction of the manipulator portion 20. In an example illustrated in FIG. 3, the temperature measuring device 40 is disposed on a left side as viewed toward the paper face in the torch supporting portion 32 when viewed from a welding torch 31 side. As described above, in the welding robot 10 in the reference posture, the temperature measuring device 40 of the present embodiment is disposed on a lateral side of the tool portion 30 in the left-right direction, not on the upper side in the vertical direction or the lower side in the vertical direction.

Further, as illustrated in FIG. 2, the temperature measuring device 40 is provided on an inner side with respect to a contour C which is the outer shape of the tool portion 30 when the welding robot 10 in the reference posture is viewed from the Y-axis direction which is the horizontal direction. The temperature measuring device 40 does not protrude to the region A1 or the region A2 even in a state in which the temperature measuring device 40 is disposed on one side of the tool portion 30 in the left-right direction.

Next, a structure of the temperature measuring device 40 will be described in detail.

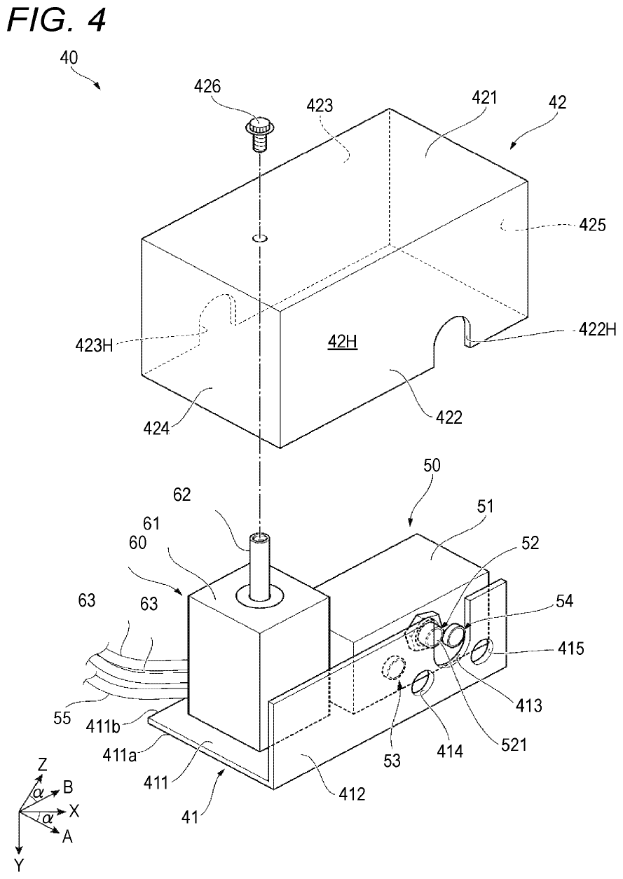

FIG. 4 is an exploded perspective view of the temperature measuring device 40 of the present embodiment.

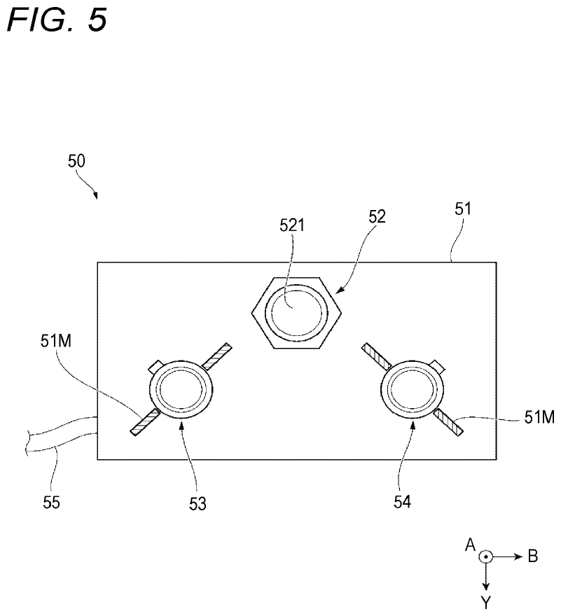

FIG. 5 is an overall view of the sensor unit 50 of the present embodiment.

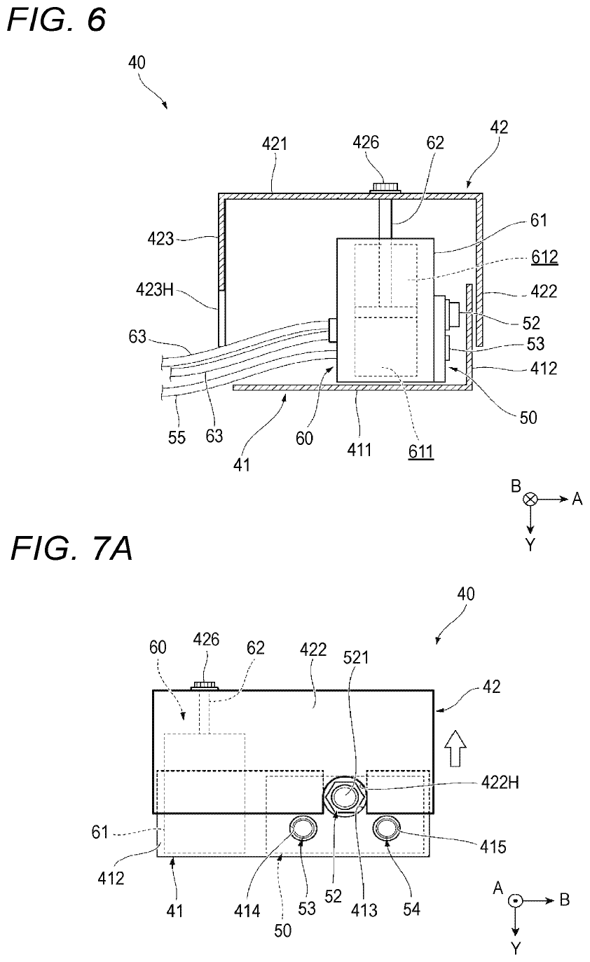

FIG. 6 is a cross-sectional view of the temperature measuring device 40 of the present embodiment.

As illustrated in FIG. 4, the temperature measuring device 40 includes a pedestal portion 41 to which various components are attached, a cover portion 42 that covers at least the temperature sensor 52 (described later), a sensor unit 50 that detects a temperature, and the air cylinder portion 60 as an example of a driving unit that drives the cover portion 42.

The pedestal portion 41 is a plate-shaped member of which the cross section is formed in an L-shape. The pedestal portion 41 includes a first surface portion 411 and a second surface portion 412 provided to rise from the first surface portion 411.

The sensor unit 50 and the air cylinder portion 60 are attached to the first surface portion 411. Further, the first surface portion 411 forms an installation surface when the temperature measuring device 40 is installed on the torch supporting portion 32 (see FIG. 2). The first surface portion 411 is provided to along an XZ plane (see FIG. 2) in a state in which the temperature measuring device 40 is installed on the torch supporting portion 32. The first surface portion 411 has a rectangular shape when viewed from the Y-axis direction, and is provided such that a short side 411a is inclined at a predetermined angle α with respect to the X axis and a long side 411b is inclined at an angle α with respect to the Z axis. Hereinafter, a direction in which the short side 411a extends is referred to as “A direction”, and a direction in which the long side 411b extends is referred to as “B direction”.

The second surface portion 412 is formed to extend in a plate shape along the Y-axis direction (see FIG. 2). The second surface portion 412 is provided to face the welding torch 31 side in a state in which the temperature measuring device 40 is installed on the torch supporting portion 32. The second surface portion 412 is provided to be interposed between the sensor unit 50 and the air cylinder portion 60, and the welding torch 31 (see FIG. 2).

Further, the second surface portion 412 includes a first opening 413, a second opening 414, and a third opening 415.

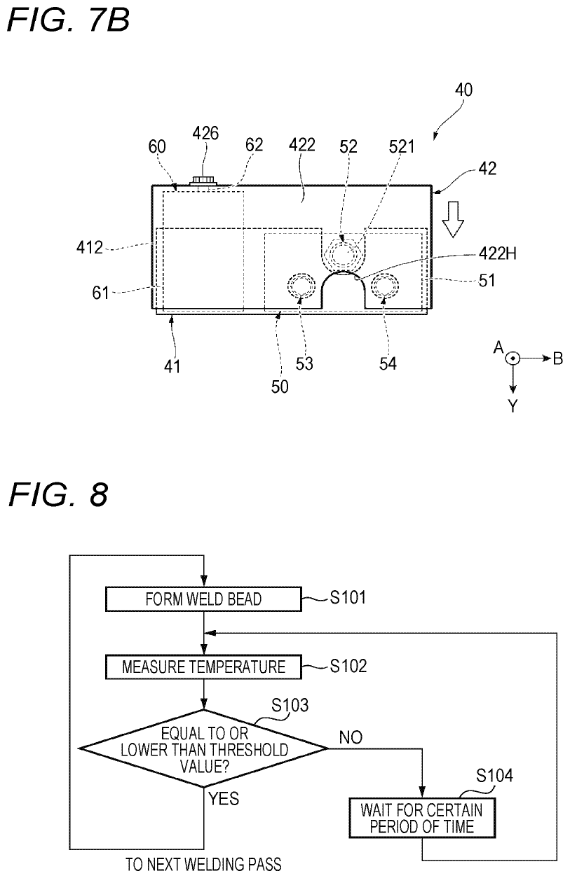

The first opening 413 is an opening formed in a U-shape. As illustrated in FIG. 7, the first opening 413 is open on a cover portion 42 side. Further, the first opening 413 is provided at a position facing a measurement lens 521 to be described later of the sensor unit 50.

The second opening 414 is an opening formed in a circular shape. Further, the second opening 414 is provided at a position facing a first laser irradiation portion 53 to be described later of the sensor unit 50.

The third opening 415 is an opening formed in a circular shape. Further, the third opening 415 is provided at a position facing a second laser irradiation portion 54 to be described later of the sensor unit 50.

Further, the second surface portion 412 is provided to face a cover surface portion 422 to be described later of the cover portion 42 (see FIG. 6). The second surface portion 412 is provided along a movement direction of the cover portion 42. The second surface portion 412 functions as an example of a guide portion that guides movement of the cover portion 42 separately from a shaft 62 to be described later of the air cylinder portion 60 when the cover portion 42 moves.

Here, as will be described later, the cover portion 42 of the present embodiment is supported only by the shaft 62 to be described later of the air cylinder portion 60. Therefore, depending on a supported state by the shaft 62, the cover portion 42 may rotate with respect to the shaft 62. In contrast, the second surface portion 412 of the present embodiment stabilizes the movement of the cover portion 42 by guiding the cover portion 42 even when the cover portion 42 tries to rotate.

As illustrated in FIG. 4, the cover portion 42 is a member formed in a box shape. The cover portion 42 includes a top surface portion 421, and the cover surface portion 422, a back surface portion 423, a first side surface portion 424, and a second side surface portion 425 that respectively rise from the top surface portion 421. The cover portion 42 is movable with respect to the pedestal portion 41 such that an opening 42H in the box shape faces the pedestal portion 41.

The cover surface portion 422 may face the measurement lens 521 to be described later of the sensor unit 50 in the temperature measuring device 40. In addition, the cover surface portion 422 has a cover opening 422H. The cover opening 422H is provided at a position corresponding to the first opening 413 of the pedestal portion 41 in the movement direction of the cover portion 42.

Further, the cover surface portion 422 moves to expose the temperature sensor 52 (described later) or cover the temperature sensor 52 according to a position of the cover opening 422H with respect to the temperature sensor 52.

The back surface portion 423 has a cable opening 423H. The cable opening 423H forms a position through which the sensor cable 55 to be described later of the sensor unit 50 and an air tube 63 to be described later of the air cylinder portion 60 pass in the back surface portion 423.

The cover portion 42 is fixed to the shaft 62 to be described later of the air cylinder portion 60. Specifically, the cover portion 42 has the top surface portion 421 sandwiched between a fixing member 426 and the shaft 62. The cover portion 42 is supported by the shaft 62. Further, the cover portion 42 moves along with an operation of the shaft 62 of the air cylinder portion 60.

As illustrated in FIG. 5, the sensor unit 50 includes an installation base 51, the temperature sensor 52 as an example of a measurement unit, the first laser irradiation portion 53 as an example of a display unit, the second laser irradiation portion 54 as an example of the display unit, and the sensor cable 55.

The installation base 51 holds the temperature sensor 52, the first laser irradiation portion 53, and the second laser irradiation portion 54. The installation base 51 is fixed to the pedestal portion 41 (see FIG. 4).

In addition, the installation base 51 has a mark 51M used when adjusting an orientation of each laser of the first laser irradiation portion 53 and the second laser irradiation portion 54.

The temperature sensor 52 includes the measurement lens 521 and a detection element (not illustrated) that detects an infrared ray collected by the measurement lens 521. The temperature sensor 52 detects infrared rays emitted from the weld bead to be measured and the workpiece W to be measured in the vicinity of the weld bead, thereby specifying temperatures of the weld bead and the workpiece W in the vicinity of the weld bead. That is, the temperature sensor 52 measures the temperatures of the weld bead and the workpiece W in the vicinity of the weld bead in a noncontact manner without contacting the weld bead to be measured or the workpiece W to be measured in the vicinity of the weld bead.

The measurement lens 521 is provided on the welding torch 31 (see FIG. 3) side of the installation base 51. The measurement lens 521 is directed toward the weld bead and the workpiece W when the temperatures of the weld bead and the workpiece W in the vicinity of the weld bead are measured by the temperature sensor 52.

For example, a thermopile can be used as the detection element. A temperature of the detection element increases by absorbing the infrared ray. The detection element outputs an electrical signal of a voltage value corresponding to the increased temperature.

The first laser irradiation portion 53 and the second laser irradiation portion 54 irradiate an object with a line laser that is a linear laser. The line laser emitted by the first laser irradiation portion 53 and the line laser emitted by the second laser irradiation portion 54 intersect at an object such as the workpiece W. The first laser irradiation portion 53 and the second laser irradiation portion 54 of the present embodiment are set such that a point at which the line lasers respectively emitted intersect each other indicates a position of the temperature measurement by the temperature sensor 52.

As described above, the temperature sensor 52 measures the temperatures of the weld bead and the workpiece W in the vicinity of the weld bead in a noncontact manner. Therefore, it is difficult for an operator to visually check the position of the measurement by the temperature sensor 52. Regarding this, in the temperature measuring device 40 of the present embodiment, the position of the temperature measurement is visualized by the first laser irradiation portion 53 and the second laser irradiation portion 54. The temperature measuring device 40 of the present embodiment allows the operator to check the position of the measurement, for example, when setting of the position of the temperature measurement is incorporated into an operation program.

The sensor cable 55 includes a signal line for transmitting an electrical signal of a voltage value output from the temperature sensor 52 to the relay box 35. In addition, the sensor cable 55 includes a feed line that supplies a current to the first laser irradiation portion 53 and the second laser irradiation portion 54, the current being for the first laser irradiation portion 53 and the second laser irradiation portion 54 to emit the line laser.

As illustrated in FIG. 6, the air cylinder portion 60 includes a cylinder portion 61, the shaft 62 as an example of a support member, and the air tube 63 as a path of air.

The cylinder portion 61 is fixed to the pedestal portion 41. In addition, one end portion of the shaft 62 is inserted into the cylinder portion 61. The cylinder portion 61 supports the shaft 62 such that the shaft 62 is movable in an axial direction.

The cylinder portion 61 includes therein a first chamber 611 and a second chamber 612 into which compressed air supplied from the air tube 63 flows. The first chamber 611 forms a space into which the compressed air flows when the shaft 62 is pushed out from the cylinder portion 61. The second chamber 612 forms a space into which the compressed air flows when the shaft 62 is drawn into the cylinder portion 61. The air tube 63 is connected to each of the first chamber 611 and the second chamber 612 so as to allow the compressed air to flow therein.

The shaft 62 is a rod-shaped member extending long in the axial direction. One end side of the shaft 62 is inserted into the cylinder portion 61. The other end side of the shaft 62 is connected to the cover portion 42. A female screw is formed in the shaft 62 of the present embodiment. The shaft 62 supports the cover portion 42 by joining the fixing member 426 to the female screw of the shaft 62 with the cover portion 42 interposed between the shaft 62 and the fixing member 426. Further, the shaft 62 is configured to be movable in the axial direction. The shaft 62 protrudes from the cylinder portion 61 or retreats toward a cylinder portion 61 side.

One end of the air tube 63 communicates with the air compressor 70 via the air control unit 351 of the relay box 35, and the other end communicates with the cylinder portion 61. The air tube 63 supplies compressed air of the air compressor 70 to the cylinder portion 61.

In the air cylinder portion 60, the compressed air is selectively supplied to any of the first chamber 611 and the second chamber 612 through the air tube 63, thereby allows the shaft 62 to protrude or retreat. The air cylinder portion 60 drives the shaft 62 to move the cover portion 42 connected to the shaft 62.

As described above, in the temperature measuring device 40 of the present embodiment, the air cylinder portion 60 is used to drive the cover portion 42, but the present invention is not limited to use the air cylinder portion 60. Other structures may be used as long as the support member supporting the cover portion 42 is driven and the cover portion 42 can be moved by moving the support member to one side and the other side in a predetermined direction.

Next, a movement operation of the cover portion 42 in the temperature measuring device 40 will be described.

FIG. 7A and FIG. 7B are explanatory views of operations of the temperature measuring device 40 of the present embodiment, and are views of the temperature measuring device 40 as viewed from an object side in the A direction.

FIG. 7A illustrates a state in which the cover portion 42 is distant from the pedestal portion 41, and FIG. 7B illustrates a state in which the cover portion 42 is adjacent to the pedestal portion 41.

As illustrated in FIG. 7A, the air cylinder portion 60 drives the shaft 62 by the compressed air supplied to the cylinder portion 61, and moves the shaft 62 in a direction away from the cylinder portion 61 in the axial direction of the shaft 62. That is, the air cylinder portion 60 pushes out the shaft 62 from the cylinder portion 61. Thus, the cover portion 42 supported by the shaft 62 moves in a direction away from the pedestal portion 41.

The cover portion 42 comes into a state in which the cover opening 422H of the cover surface portion 422 faces the measurement lens 521 of the temperature sensor 52. Accordingly, the cover portion 42 is brought into a state of exposing the measurement lens 521 of the temperature sensor 52.

In addition, since the cover portion 42 moves in the direction away from the pedestal portion 41, the cover surface portion 422 is brought into a state of exposing the first laser irradiation portion 53 and the second laser irradiation portion 54.

Here, in the temperature measuring device 40 of the present embodiment, the second surface portion 412 of the pedestal portion 41 is provided between the cover portion 42 and the temperature sensor 52, the first laser irradiation portion 53, and the second laser irradiation portion 54. The second surface portion 412 exposes the measurement lens 521 at the first opening 413, but covers a periphery of the measurement lens 521. In addition, the second surface portion 412 exposes the first laser irradiation portion 53 and the second laser irradiation portion 54 by the second opening 414 and the third opening 415, but covers a periphery of each of the first laser irradiation portion 53 and the second laser irradiation portion 54.

As described above, in the temperature measuring device 40, the second surface portion 412 of the pedestal portion 41 covers peripheries of the temperature sensor 52, the first laser irradiation portion 53, and the second laser irradiation portion 54 in a state in which the cover portion 42 exposes the temperature sensor 52, the first laser irradiation portion 53, and the second laser irradiation portion 54. In this way, the temperature measuring device 40 protects the temperature sensor 52, the first laser irradiation portion 53, and the second laser irradiation portion 54 while enabling the temperature measurement and irradiation of the line laser.

As illustrated in FIG. 7B, the air cylinder portion 60 drives the shaft 62 by the compressed air supplied to the cylinder portion 61, and moves the shaft 62 in a direction approaching the cylinder portion 61 in the axial direction of the shaft 62. That is, the air cylinder portion 60 draws the shaft 62 into the cylinder portion 61. Thus, the cover portion 42 supported by the shaft 62 moves in a direction approaching the pedestal portion 41.

In the cover portion 42, the cover opening 422H of the cover surface portion 422 is retreated from the measurement lens 521 of the temperature sensor 52. As a result, the cover portion 42 comes into a state in which a region where the cover opening 422H is not formed faces the temperature sensor 52. Accordingly, the cover portion 42 comes into a state of covering the measurement lens 521 of the temperature sensor 52.

In addition, since the cover portion 42 moves in the direction approaching the pedestal portion 41, the cover surface portion 422 comes into a state of covering the first laser irradiation portion 53 and the second laser irradiation portion 54.

The cover portion 42 of the present embodiment is formed in a box shape as described with reference to FIG. 4. Accordingly, the cover portion 42 moves in the direction approaching the pedestal portion 41, thereby coming into a state of entirely enclosing the sensor unit 50 and the air cylinder portion 60 installed on the pedestal portion 41.

The temperature measuring device 40 of the present embodiment drives the shaft 62 to move the shaft 62 to one side and the other side along the axial direction of the shaft 62, and move the cover portion 42. As described above, in the temperature measuring device 40 of the present embodiment, the movement of the cover portion 42 is realized by a simple and compact configuration.

In particular, in the temperature measuring device 40 of the present embodiment, the cover portion 42 is directly supported by the shaft 62 of the air cylinder portion 60. In addition, in the temperature measuring device 40, a direction in which the cover portion 42 moves when the cover portion 42 exposes or covers the temperature sensor 52 is the same as a direction in which the shaft 62, which is the drive shaft of the air cylinder portion 60, moves. In this respect, the temperature measuring device 40 of the present embodiment has a simple and compact configuration, as compared with a configuration in which, for example, another structural portion is interposed between the air cylinder portion 60 and the cover portion 42, or the cover portion 42 is moved such that power is transmitted in a direction different from the movement direction of the shaft 62 which is the drive shaft of the air cylinder portion 60.

The temperature measuring device 40 of the present embodiment may include an air blower that injects compressed air into the sensor unit 50. In the temperature measuring device 40, the compressed air injected by the air blower may blow off foreign matters adhering to the temperature sensor 52, the first laser irradiation portion 53, and the second laser irradiation portion 54. In this case, the compressed air used for the air blower can be supplied from the air compressor 70.

A measurement axis of the temperature sensor 52 of the temperature measuring device 40 configured as described above will be described.

As illustrated in FIG. 3, an XZ plane through which a central axis L1 of the welding torch 31 passes and an XZ plane through which a measurement axis L2 of the temperature sensor 52 passes are distant by a certain distance in the Y-axis direction. In the welding robot 10 of the present embodiment, interference between the measurement axis L2 of the temperature sensor 52 and the central axis L1 of the welding torch 31 is avoided. That is, the temperature measuring device 40 is not affected by a temperature of the welding torch 31 when a temperature of the object is to be measured.

In the welding robot 10 of the present embodiment, the measurement axis L2 of the temperature sensor 52 of the temperature measuring device 40 is set to correspond to the weld bead and the workpiece W in the vicinity of the weld bead. As a result, the temperature measuring device 40 can measure the temperatures of the weld bead and the workpiece W in the vicinity of the weld bead.

As described above, the relative positional relation between the welding torch 31 and the temperature measuring device 40 is fixed. Therefore, a position of the measurement axis L2 of the temperature sensor 52 of the temperature measuring device 40 can be easily calculated based on coordinates of an arc point of the welding torch 31.

### [Air Compressor 70]

The air compressor 70 illustrated in FIG. 1 supplies air compressed by driving a rotor or a piston to a supply destination of the compressed air.

Here, in a case where the slag chipper as the tool portion 30 is mounted on the manipulator portion 20, the air compressor 70 supplies the compressed air to the slag chipper in order to drive a needle of the slag chipper.

In addition, the air compressor 70 supplies the compressed air to the air cylinder portion 60 of the temperature measuring device 40. Thus, the air compressor 70 also drives the air cylinder portion 60.

As described above, the welding device 1 of the present embodiment includes the air compressor 70 that supplies compressed air used when another tool such as a slag chipper is adopted instead of the welding torch 31. In the temperature measuring device 40, the air compressor 70 used when the another tool is adopted is used to drive the cover portion 42.

In the welding device 1, the air compressor 70 can be used not only for driving the needle of the slag chipper, but also for the following operations.

The air compressor 70 can be used to drive a tool changer that exchanges the welding torch 31 with a slag chipper.

In addition, the air compressor 70 can be used for air injection of an air blower for blowing off slag removed by the slag chipper.

In addition, the air compressor 70 can be used for driving a wire clamp that maintains a protruding amount of the welding wire at a tip end of the welding torch 31 in the welding torch 31.

In addition, the air compressor 70 can be used for air injection of an air blower for cleaning a foreign matter adhering to the tip end of the welding torch 31.

Further, the air compressor 70 can be used for driving a wire cutter for cutting the welding wire.

### [Control Device 80]

The control device 80 illustrated in FIG. 1 is configured by, for example, a computer. The computer is configured by a central processing unit (CPU) that executes a control program, a nonvolatile semiconductor memory that stores a startup program and the like, a volatile semiconductor memory in which the control program is executed, a hard disk device that records various kinds of information collected from the welding robot 10, and the like.

The control device 80 controls operations of the welding robot 10 and the air compressor 70.

In order to perform welding on the workpiece W, the control device 80 controls a movement operation of the manipulator portion 20 based on a welding program set in advance based on a shape or the like of the workpiece W. Further, the control device 80 controls a welding operation of the welding torch 31 in the tool portion 30.

In addition, the control device 80 controls the temperature measurement of the temperature measuring device 40 and the operation of the cover portion 42. The control device 80 processes information on a temperature acquired from the temperature measuring device 40.

Further, the control device 80 includes an operation program for determining a timing at which the temperature sensor 52 is covered or exposed by the cover portion 42. The operation program defines that the cover portion 42 is brought into a state of covering the temperature sensor 52 when the welding is performed on the workpiece W. In addition, the operation program defines that the cover portion 42 is brought into a state of exposing the temperature sensor 52 in a predetermined period after one weld bead is formed and before a next welding pass is welded. The control device 80 controls the operation of the cover portion 42 in the temperature measuring device 40 via the air control unit 351 of the relay box 35.

Next, a welding operation using the welding device 1 will be specifically described.

FIG. 8 is a flowchart illustrating an example of an operation flow of the welding device 1 of the present embodiment.

Hereinafter, an example will be described in which the welding device 1 is used to perform multilayer welding in which one weld bead formed in one welding pass and another weld bead formed in another welding pass are laminated on the workpiece W.

As illustrated in FIG. 8, first, a welding task is started (step 101). When the welding task is started, the welding robot 10 moves the welding torch 31 to a predetermined position on the workpiece W using the manipulator portion 20 in accordance with control of the control device 80. Then, the welding robot 10 starts welding to the workpiece W using the welding torch 31.

When the welding to the workpiece W using the welding torch 31 is started, the cover portion 42 is in the state of covering the temperature sensor 52 in the temperature measuring device 40. When the welding is performed by the welding torch 31, the temperature sensor 52 in the temperature measuring device 40 is protected from spatter, fume, and radiant heat generated with the formation of the weld bead.

When the formation of the weld bead in one welding pass is completed, measurement of a temperature of the weld bead in one welding pass is executed (step 102).

In this case, the cover portion 42 is brought into the state of exposing the temperature sensor 52 in the temperature measuring device 40.

The control device 80 controls the manipulator portion 20 according to an operation program created in advance, and moves the temperature measuring device 40 to a position where the temperature sensor 52 can measure the temperature of the weld bead in one welding pass on the workpiece W. Then, the control device 80 specifies the temperature of the weld bead based on a voltage value measured by the temperature sensor 52.

As described above, in the temperature measuring device 40 of the present embodiment, the cover portion 42 is in a state of exposing the temperature sensor 52 in the predetermined period after the one weld bead is formed and before the next welding pass is welded, and measures the temperature of the one weld bead by the temperature sensor 52.

Next, the control device 80 determines whether the measured temperature of the weld bead is equal to or lower than a threshold value (step 103).

When the measured temperature of the weld bead is equal to or lower than the threshold value (YES in step 103), the control device 80 returns to step 101 and proceeds to formation of another welding pass following the one welding pass. In this way, the multilayer welding in which another weld bead is laminated on one weld bead is performed.

On the other hand, when the temperature of the weld bead in the one welding pass exceeds the threshold value (NO in step 103), the control device 80 does not start welding to the another welding pass following the one welding pass, and waits for a certain period of time (step 104). Thereafter, when the certain period of time has elapsed, the temperature of the weld bead in the one welding pass is measured again (step 102).

In step 104, instead of waiting for a certain period of time, or in addition to waiting for a certain period of time, cooling of the workpiece W may be performed, or welding work at another position in the workpiece W may be performed.

Thereafter, when it is determined that the measured temperature of the weld bead in the one welding pass is equal to or lower than the threshold value (YES in step 103), the control device 80 returns to step 101 and proceeds to the formation of the another welding pass following the one welding pass.

In the above-described operation, an example in which the temperature of the weld bead is measured using the temperature measuring device 40 is used, but the present invention is not limited to this example. The temperature measuring device 40 may measure a temperature of the workpiece W in the vicinity of the formed weld bead.

In addition, in the case of the above-described embodiment, the welding robot 10 is assumed to be a steel frame welding robot used for welding a steel frame, but the welding robot 10 is not limited to the steel frame welding robot as long as the welding robot 10 is an application in which measurement of a temperature of one weld bead or a temperature of the workpiece W in the vicinity of the one weld bead is required in a predetermined period after one weld bead is formed and before a next welding pass is welded in multilayer welding.

Further, in the above-described embodiment, an example in which the welding robot 10 is an articulated robot has been described, but the welding robot 10 may be a single-articulated robot. In this case also, the temperature measuring device 40 may be provided in a movable portion that moves a welding torch.

Although various embodiments have been described above with reference to the drawings, it is needless to say that the present invention is not limited to such examples. It will be apparent to those skilled in the art that various alterations or modifications can be conceived within the scope described in claims, and it should be understood that they also justifiably belong to the technical scope of the present invention. Each component in the various embodiments described above may be combined arbitrarily in the range without deviating from the spirit of the invention.

The present application is based on a Japanese patent application (Japanese Patent Application No. 2021-071102) filed on Apr. 20, 2021, the contents of which are incorporated in the present application by reference.

### REFERENCE SIGNS LIST

1: welding device
10: welding robot
20: manipulator portion
30: tool portion
31: welding torch
32: torch supporting portion
35: relay box
40: temperature measuring device
41: pedestal portion
42: cover portion
50: sensor unit
52: temperature sensor
53: first laser irradiation portion
54: second laser irradiation portion
60: air cylinder portion
70: air compressor
80: control device

1. A welding device capable of performing a multilayer welding on an object to be welded, comprising:
a welding torch;
a movable portion configured to move the welding torch;
a measurement unit that is provided in the movable portion and is capable of measuring, in a predetermined period after one weld bead is formed and before a next welding pass is welded, at least one of a temperature of the one weld bead or a temperature of the object to be welded in the vicinity of the one weld bead;
a cover portion capable of covering the measurement unit at least; and
a driving unit configured to drive a support member supporting the cover portion to move the support member in a predetermined direction to bring the cover portion into a state of covering the measurement unit when the weld bead is formed, and drive the support member to move the support member in a direction opposite to the predetermined direction to bring the cover portion into a state of exposing the measurement unit in the predetermined period.

2. The welding device according to claim 1, wherein
the driving unit is configured to drive the support member using compressed air.

3. The welding device according to claim 2, further comprising:
a supply unit configured to supply compressed air used when another tool is used instead of the welding torch, wherein
the driving unit is configured to drive the support member using the compressed air supplied by the supply unit.

4. The welding device according to claim 1, further comprising:
a guide portion configured to guide a movement of the cover portion separately from the driving unit when the cover portion moves.

5. The welding device according to claim 4, wherein
the guide portion covers a periphery of the measurement unit such that a temperature measurement by the measurement unit is possible in a state in which the cover portion exposes the measurement unit.

6. The welding device according to claim 1, further comprising:
a display unit configured to indicate a position of the temperature measurement by the measurement unit on the object to be welded.

7. The welding device according to claim 6, wherein
the display unit is covered together with the measurement unit by the cover portion when the cover portion covers the measurement unit, and is exposed together with the measurement unit when the cover portion exposes the measurement unit.

8. The welding device according to claim 1, wherein
the movable portion includes a plurality of link portions configured to be movable via a drive shaft, and
the measurement unit is held by the link portion to which the welding torch is attached.

9. The welding device according to claim 8, wherein
the measurement unit is disposed on at least one side in a left-right direction of the movable portion in a reference posture.

10. A temperature measuring device used in a welding device capable of performing a multilayer welding on an object to be welded by moving a welding torch by a movable portion, the temperature measuring device comprising:
a measurement unit that is provided in the movable portion and is capable of measuring, in a predetermined period after one weld bead is formed and before a next welding pass is welded, at least one of a temperature of the one weld bead or a temperature of the object to be welded in the vicinity of the one weld bead;
a cover portion capable of covering the measurement unit at least; and
a driving unit configured to drive a support member supporting the cover portion to move the support member in a predetermined direction to bring the cover portion into a state of covering the measurement unit when the weld bead is formed, and drive the support member to move the support member in a direction opposite to the predetermined direction to bring the cover portion into a state of exposing the measurement unit in the predetermined period.
